(19) United States
(12) Patent Application Publication
(10) Pub. No.: US 2026/0346911 A1
(43) Pub. Date: Nov. 5, 2026

(54) VEHICLE DRIVING ASSISTANCE APPARATUS, VEHICLE DRIVING ASSISTANCE METHOD, AND STORAGE MEDIUM STORING VEHICLE DRIVING ASSISTANCE PROGRAM

(71) Applicant: TOYOTA JIDOSHA KABUSHIKI KAISHA, Toyota-shi (JP)

(72) Inventor: Hajime NAGAE, Toyota-shi (JP)

(73) Assignee: TOYOTA JIDOSHA KABUSHIKI KAISHA, Toyota-shi (JP)

(21) Appl. No.: 19/541,774

(22) Filed: Feb. 17, 2026

(30) Foreign Application Priority Data
Mar. 21, 2025 (JP) 2025-046681

(51) Int. Cl. B62D 6/00

(52) U.S. Cl. CPC B62D 6/001

(57) ABSTRACT

A vehicle driving assistance apparatus executes a steering control of autonomously applying a steering torque to a steering mechanism of a host vehicle such that the host vehicle travels along a target traveling line. When the host vehicle deviates from the target traveling line, the apparatus calculates a feedback steering torque for making a deviation amount from the target traveling line zero, and applies the feedback steering torque to the steering mechanism. The apparatus detects an adjacent vehicle and detects a positional relationship between the adjacent and host vehicles. The apparatus determines whether an inter-vehicle pressure between the host and adjacent vehicles is an attracting pressure or a pushing pressure based on the positional relationship, and reduces the feedback steering torque to zero within a predetermined time at a timing when the inter-vehicle pressure changes from the attracting pressure to the pushing pressure.

### CROSS-REFERENCE TO RELATED APPLICATIONS

This application claims priority to Japanese patent application No. JP 2025-046681 filed on Mar. 21, 2025, the content of which is hereby incorporated by reference in its entirety.

### BACKGROUND

### Field

The present invention relates to a vehicle driving assistance apparatus, a vehicle driving assistance method, and a computer-readable storage medium storing a vehicle driving assistance program.

### Description of the Related Art

When a host vehicle is traveling alongside an adjacent vehicle in order to overtake the adjacent vehicle, an attracting pressure that draws the host vehicle toward the adjacent vehicle is generated between the host vehicle and the adjacent vehicle. On the other hand, when the host vehicle overtakes the adjacent vehicle, a pushing pressure that pushes the host vehicle in a direction away from the adjacent vehicle is generated between the host vehicle and the adjacent vehicle. There is known a vehicle driving assistance apparatus that executes a lane keeping control in consideration of such attracting pressure and pushing pressure (for example, see Japanese Patent Application Laid-Open No. 2019-038394). It should be noted that the lane keeping control is a steering control of autonomously applying a steering torque to a steering mechanism of the host vehicle such that the host vehicle travels within a lane.

In the conventional vehicle driving assistance apparatus, during execution of the lane keeping control, a feedback steering torque calculated by a feedback control based on a deviation amount of the host vehicle from a target traveling line is applied to a steering mechanism of the host vehicle. In this case, during execution of the lane keeping control, while the host vehicle is traveling alongside the adjacent vehicle in order to overtake the adjacent vehicle, the feedback steering torque becomes large due to an influence of the attracting pressure. Accordingly, at a timing when the host vehicle overtakes the adjacent vehicle and the pushing pressure is generated, an excessive feedback steering torque is applied to the steering mechanism of the host vehicle. According to this, a behavior of the host vehicle becomes unstable.

### SUMMARY

An object of the present invention is to provide a vehicle driving assistance apparatus, a vehicle driving assistance method, and a computer-readable storage medium storing a vehicle driving assistance program that are capable of suppressing instability of a behavior of the host vehicle during execution of the steering control of autonomously applying a steering torque to the host vehicle such that the vehicle travels along a target traveling line within a host vehicle traveling lane.

A vehicle driving assistance apparatus according to the present invention comprises an electronic control unit that executes a steering control of setting, within a host vehicle traveling lane in which a host vehicle is traveling, a target traveling line extending along the host vehicle traveling lane, and autonomously applying a steering torque to a steering mechanism of the host vehicle such that the host vehicle travels along the target traveling line. The electronic control unit is configured to, during execution of the steering control, when the host vehicle deviates from the target traveling line, calculate a feedback steering torque that is a steering torque to be applied to the steering mechanism in order to make a deviation amount of the host vehicle from the target traveling line zero, and apply a steering torque corresponding to the feedback steering torque to the steering mechanism. Further, the electronic control unit is configured to detect an adjacent vehicle that is another vehicle traveling in the same direction as the host vehicle in a lane adjacent to the host vehicle traveling lane and traveling ahead of the host vehicle, and detect a positional relationship between the adjacent vehicle and the host vehicle. Furthermore, the electronic control unit is configured to, during execution of the steering control, determine whether an inter-vehicle pressure generated between the host vehicle and the adjacent vehicle is an attracting pressure or a pushing pressure based on the positional relationship, and reduce the feedback steering torque to zero within a predetermined time at a timing when the inter-vehicle pressure changes from the attracting pressure to the pushing pressure.

When the host vehicle is traveling alongside the adjacent vehicle in order to overtake the adjacent vehicle, the attracting pressure that draws the host vehicle toward the adjacent vehicle is applied to the host vehicle. As a result, the host vehicle deviates from the target traveling line. During execution of the steering control, the feedback steering torque gradually increases in order to eliminate this deviation.

On the other hand, when the host vehicle overtakes the adjacent vehicle, the pushing pressure that pushes the host vehicle in a direction away from the adjacent vehicle is applied to the host vehicle. That is, the inter-vehicle pressure generated between the host vehicle and the adjacent vehicle changes from the attracting pressure to the pushing pressure. At this time, if the feedback steering torque remains large, the host vehicle is largely steered in a direction away from the adjacent vehicle, and the behavior of the host vehicle becomes unstable.

According to the vehicle driving assistance apparatus of the present invention, when the inter-vehicle pressure generated between the host vehicle and the adjacent vehicle changes from the attracting pressure to the pushing pressure, the feedback steering torque is made zero within the predetermined time. Accordingly, instability of the behavior of the host vehicle is suppressed.

In the vehicle driving assistance apparatus according to an aspect of the present invention, the electronic control unit may be configured to determine whether or not the attracting pressure is generated based on a positional relationship between a front end of the host vehicle and a rear end of the adjacent vehicle.

The attracting pressure is generated when the host vehicle starts overtaking the adjacent vehicle. Accordingly, whether the attracting pressure is generated is related to the positional relationship between the front end of the host vehicle and the rear end of the adjacent vehicle. According to the vehicle driving assistance apparatus of this aspect of the present invention, whether the attracting pressure is generated is determined based on the positional relationship between the front end of the host vehicle and the rear end of the adjacent vehicle. Accordingly, whether the attracting pressure is generated can be accurately determined.

Further, in the vehicle driving assistance apparatus according to another aspect of the present invention, the electronic control unit may be configured to determine whether or not the pushing pressure is generated based on a positional relationship between a front end of the host vehicle and a front end of the adjacent vehicle.

The pushing pressure is generated when the host vehicle completes overtaking the adjacent vehicle. Accordingly, whether the pushing pressure is generated is related to the positional relationship between the front end of the host vehicle and the front end of the adjacent vehicle. According to the vehicle driving assistance apparatus of this aspect of the present invention, whether the pushing pressure is generated is determined based on the positional relationship between the front end of the host vehicle and the front end of the adjacent vehicle. Accordingly, whether the pushing pressure is generated can be accurately determined.

Furthermore, a vehicle driving assistance method according to the present invention is a method of executing a steering control of setting, within a host vehicle traveling lane in which a host vehicle is traveling, a target traveling line extending along the host vehicle traveling lane, and autonomously applying a steering torque to a steering mechanism of the host vehicle such that the host vehicle travels along the target traveling line. The vehicle driving assistance method comprises a step of, during execution of the steering control, when the host vehicle deviates from the target traveling line, calculating a feedback steering torque that is a steering torque to be applied to the steering mechanism in order to make a deviation amount of the host vehicle from the target traveling line zero, and applying a steering torque corresponding to the feedback steering torque to the steering mechanism. Further, the vehicle driving assistance method comprises a step of detecting an adjacent vehicle that is another vehicle traveling in the same direction as the host vehicle in a lane adjacent to the host vehicle traveling lane and traveling ahead of the host vehicle, and detecting a positional relationship between the adjacent vehicle and the host vehicle. Furthermore, the vehicle driving assistance method comprises a step of, during execution of the steering control, determining whether an inter-vehicle pressure generated between the host vehicle and the adjacent vehicle is an attracting pressure or a pushing pressure based on the positional relationship, and reducing the feedback steering torque to zero within a predetermined time at a timing when the inter-vehicle pressure changes from the attracting pressure to the pushing pressure.

According to the vehicle driving assistance method of the present invention, for the same reasons as described above, instability of the behavior of the host vehicle is suppressed.

Furthermore, a computer-readable non-transitory storage medium according to the present invention stores a vehicle driving assistance program which executes a steering control of setting, within a host vehicle traveling lane in which a host vehicle is traveling, a target traveling line extending along the host vehicle traveling lane, and autonomously applying a steering torque to a steering mechanism of the host vehicle such that the host vehicle travels along the target traveling line. The vehicle driving assistance program is configured to, during execution of the steering control, when the host vehicle deviates from the target traveling line, calculate a feedback steering torque that is a steering torque to be applied to the steering mechanism in order to make a deviation amount of the host vehicle from the target traveling line zero, and apply a steering torque corresponding to the feedback steering torque to the steering mechanism. Further, the vehicle driving assistance program is configured to detect an adjacent vehicle that is another vehicle traveling in the same direction as the host vehicle in a lane adjacent to the host vehicle traveling lane and traveling ahead of the host vehicle, and detect a positional relationship between the adjacent vehicle and the host vehicle. Furthermore, the vehicle driving assistance program is configured to, during execution of the steering control, determine whether an inter-vehicle pressure generated between the host vehicle and the adjacent vehicle is an attracting pressure or a pushing pressure based on the positional relationship, and reduce the feedback steering torque to zero within a predetermined time at a timing when the inter-vehicle pressure changes from the attracting pressure to the pushing pressure.

According to the vehicle driving assistance program of the present invention, for the same reasons as described above, instability of the behavior of the host vehicle is suppressed.

Constituent elements of the present invention are not limited to embodiments of the present invention described later with reference to the drawings. Other objects, other features, and attendant advantages of the present invention will be readily understood from the description of the embodiments of the present invention.

### BRIEF DESCRIPTION OF THE DRAWINGS

FIG. 1 is a diagram illustrating a vehicle driving assistance apparatus according to an embodiment of the present invention.

FIG. 2 is a flowchart illustrating a routine executed by the vehicle driving assistance apparatus according to the embodiment of the present invention.

FIG. 3 is a diagram illustrating a target traveling line and a deviation amount.

FIG. 4 is a diagram illustrating an adjacent vehicle.

FIG. 5 is a diagram illustrating a rear end distance and a front end distance.

### DETAILED DESCRIPTION

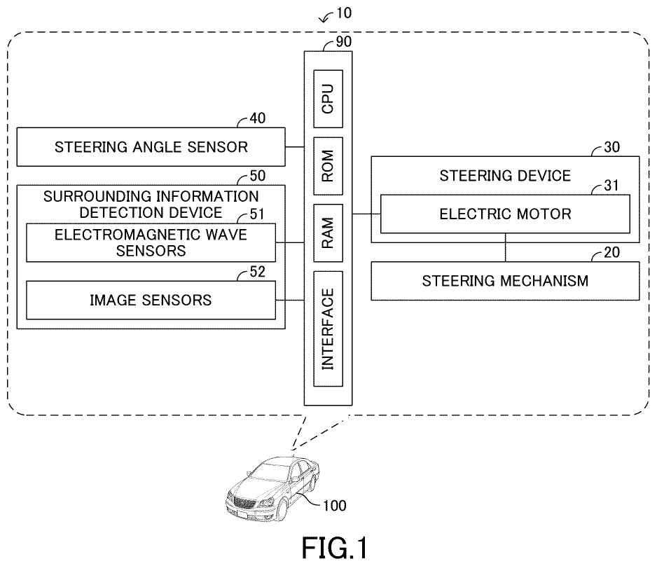

Hereinafter, a vehicle driving assistance apparatus, a vehicle driving assistance method, and a vehicle driving assistance program according to an embodiment of the present invention will be described with reference to the drawings. FIG. 1 illustrates a vehicle driving assistance apparatus 10 according to the embodiment of the present invention. The vehicle driving assistance apparatus 10 is mounted on a host vehicle 100. Hereinafter, the vehicle driving assistance apparatus 10 will be described by taking as an example a case in which an operator of the host vehicle 100 is a driver of the host vehicle 100 (that is, a person who rides in the host vehicle 100 and drives the host vehicle 100). However, the operator of the host vehicle 100 may be a remote operator of the host vehicle 100 (that is, a person who remotely drives the host vehicle 100 without riding in the host vehicle 100).

As shown in FIG. 1, the vehicle driving assistance apparatus 10 includes an ECU (electronic control unit) 90 as a control device. The ECU 90 includes a microcomputer as a main component. The microcomputer includes a CPU, a computer readable storage medium, an interface, and the like. The storage medium includes a ROM, a RAM, a non-volatile memory, and the like. The CPU realizes various functions by executing instructions, programs, or routines stored in the storage medium. In particular, in this example, the vehicle driving assistance apparatus 10 stores, in the storage medium, programs for realizing various controls executed by the vehicle driving assistance apparatus 10.

It should be noted that, in this example, the vehicle driving assistance apparatus 10 includes only one ECU 90; however, the vehicle driving assistance apparatus 10 may include a plurality of ECUs and be configured such that functions of the vehicle driving assistance apparatus 10 described below are respectively shared and executed by the ECUs.

Further, the vehicle driving assistance apparatus 10 may be configured such that programs stored in the storage medium can be updated (upgraded) by wireless communication (for example, Internet communication) with external devices.

Further, the vehicle driving assistance apparatus 10 is applicable not only to a vehicle that is driven by manual driving by an operator but also to a vehicle that is driven by automated driving.

As shown in FIG. 1, the host vehicle 100 is equipped with a steering mechanism 20, a steering device 30, a steering angle sensor 40, and a surrounding information detection device 50.

The steering mechanism 20 includes a steering wheel, a column, an intermediate shaft, and a rack-and-pinion gear. The column is connected to the steering wheel and the intermediate shaft. That is, the column connects the steering wheel to the intermediate shaft. Further, the rack-and-pinion gear is connected to the intermediate shaft and steering wheels of the host vehicle 100. That is, the rack-and-pinion gear connects the intermediate shaft to the steering wheels of the host vehicle 100.

The steering device 30 applies a steering torque to the steering mechanism 20 in order to steer the host vehicle 100. The steering device 30 includes an electric motor 31. The steering device 30 applies a steering torque from the electric motor 31 to the steering mechanism 20. For example, the steering device 30 applies a steering torque from the electric motor 31 to the column, or to a pinion portion or a rack portion of the rack-and-pinion gear.

The steering angle sensor 40 is used to detect a steering angle θ of the steering wheels of the host vehicle 100. The steering angle sensor 40 is electrically connected to the ECU 90. The vehicle driving assistance apparatus 10 detects the steering angle θ of the steering wheels of the host vehicle 100 by the steering angle sensor 40, and acquires the steering angle θ as an actual steering angle θact.

The surrounding information detection device 50 is used to detect information on surroundings of the host vehicle 100. In this example, the surrounding information detection device 50 includes a plurality of electromagnetic wave sensors 51 and a plurality of image sensors 52. The electromagnetic wave sensors 51 and the image sensors 52 are electrically connected to the ECU 90. The electromagnetic wave sensors 51 are, for example, radar sensors such as millimeter-wave radars. The vehicle driving assistance apparatus 10 acquires information (object information IO) on objects present around the host vehicle 100 as surrounding information IS by the electromagnetic wave sensors 51. Further, the image sensors 52 are, for example, camera sensors. The vehicle driving assistance apparatus 10 acquires image information IC on surroundings of the host vehicle 100 as surrounding information IS by the image sensors 52.

### Operation of Vehicle Driving Assistance Apparatus

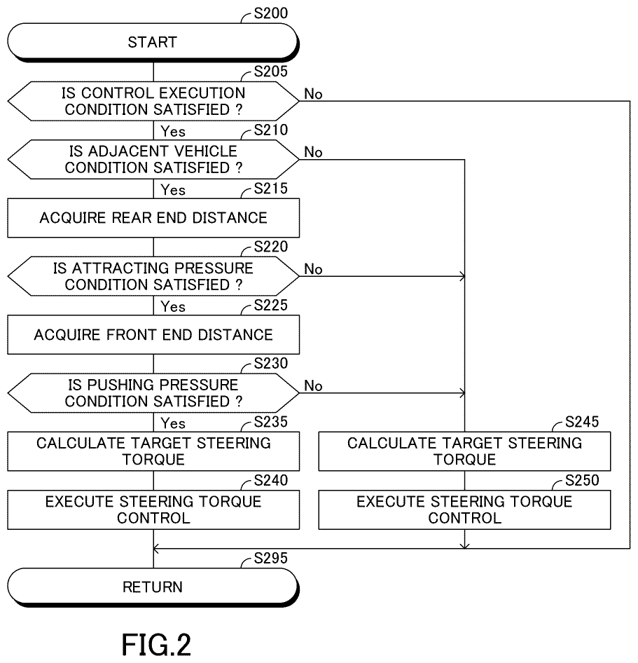

Next, the operation of the vehicle driving assistance apparatus 10 will be described. The vehicle driving assistance apparatus 10 executes a routine shown in FIG. 2 at predetermined time intervals. Accordingly, when execution of a lane keeping control is requested, the vehicle driving assistance apparatus 10 executes the lane keeping control as a driving assistance control.

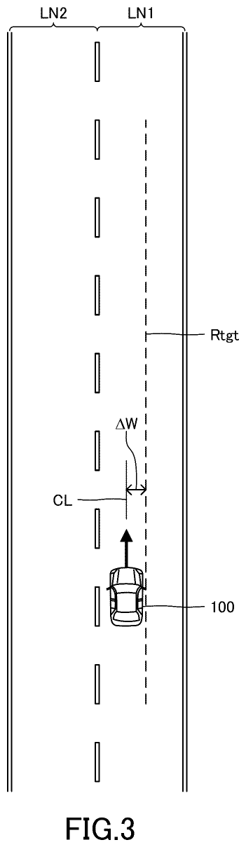

The lane keeping control is a steering control of setting a target traveling line Rtgt within a host vehicle traveling lane LN1 and autonomously applying a steering torque to the steering mechanism 20 such that the host vehicle 100 travels along the target traveling line Rtgt. Accordingly, as shown in FIG. 3, during execution of the lane keeping control, when a center line CL of the host vehicle 100 deviates leftward from the target traveling line Rtgt, the vehicle driving assistance apparatus 10 autonomously applies a steering torque to the steering mechanism 20 such that the host vehicle 100 moves rightward.

It should be noted that the host vehicle traveling lane LN1 is a lane in which the host vehicle 100 is traveling. Further, the center line CL is a line extending in a front-rear direction of the host vehicle 100 and passing through a midpoint in a width direction of the host vehicle 100. Further, the target traveling line Rtgt is a line extending along the host vehicle traveling lane LN1. In this example, the target traveling line Rtgt is a line passing through a midpoint in a width direction of the host vehicle traveling lane LN1.

On the other hand, during execution of the lane keeping control, when the center line CL of the host vehicle 100 deviates rightward from the target traveling line Rtgt, the vehicle driving assistance apparatus 10 autonomously applies a steering torque to the steering mechanism 20 such that the host vehicle 100 moves leftward.

At a predetermined timing, the vehicle driving assistance apparatus 10 starts processing from a step S200 of the routine shown in FIG. 2. Then, the vehicle driving assistance apparatus 10 proceeds with the process to a step S205 to determine whether or not a control execution condition C1 is satisfied. The control execution condition C1 is satisfied when execution of the lane keeping control is requested.

When the vehicle driving assistance apparatus 10 determines “No” at the step S205, the vehicle driving assistance apparatus 10 proceeds with the process directly to a step S295 to terminate the process of this routine once. In this case, the vehicle driving assistance apparatus 10 does not execute the lane keeping control. Alternatively, when the vehicle driving assistance apparatus 10 determines “No” at the step S205 while executing the lane keeping control, the vehicle driving assistance apparatus 10 terminates the lane keeping control.

On the other hand, when the vehicle driving assistance apparatus 10 determines “Yes” at the step S205, the vehicle driving assistance apparatus 10 proceeds with the process to a step S210 to determine whether or not an adjacent vehicle condition C2 is satisfied.

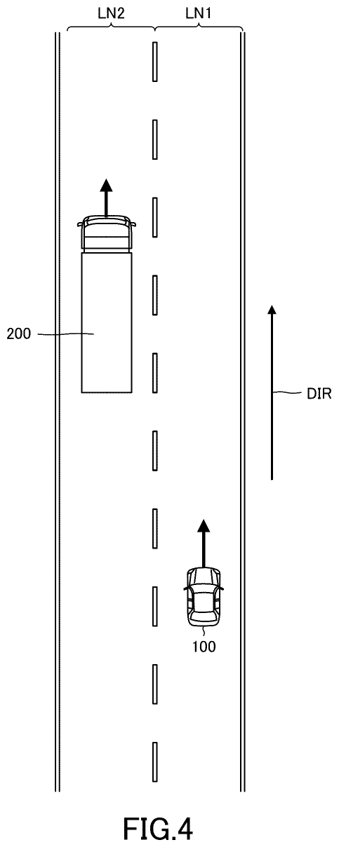

The adjacent vehicle condition C2 is satisfied when an adjacent vehicle 200 exists. As shown in FIG. 4, the adjacent vehicle 200 is another vehicle that travels in a lane LN2 adjacent to the host vehicle traveling lane LN1 in the same direction as a host vehicle traveling direction DIR and travels ahead of the host vehicle 100. In particular, the adjacent vehicle 200 is another vehicle that travels in the lane LN2 adjacent to the host vehicle traveling lane LN1 in the same direction as the host vehicle traveling direction DIR and travels within a predetermined distance Dth ahead of the host vehicle 100. The vehicle driving assistance apparatus 10 detects the adjacent vehicle 200 based on the surrounding information IS. Further, the vehicle driving assistance apparatus 10 acquires a distance between the host vehicle 100 and the adjacent vehicle 200 based on the surrounding information IS. Further, the host vehicle traveling direction DIR is a direction in which the host vehicle 100 is traveling.

When the vehicle driving assistance apparatus 10 determines “No” at the step S210, the vehicle driving assistance apparatus 10 proceeds with the process to a step S245 to calculate a target steering torque TQtgt as follows.

The vehicle driving assistance apparatus 10 performs a process of acquiring a deviation amount ΔW during execution of the lane keeping control. As shown in FIG. 3, the deviation amount ΔW is an amount by which the host vehicle 100 deviates laterally from the target traveling line Rtgt. More specifically, the deviation amount ΔW is an amount by which the center line CL of the host vehicle 100 deviates laterally from the target traveling line Rtgt.

Then, the vehicle driving assistance apparatus 10 sets a target steering angle θtgt based on the deviation amount ΔW. The target steering angle θtgt is a steering angle θ to be targeted in order to make the deviation amount ΔW zero. The target steering angle θtgt is set to a larger value as the deviation amount ΔW becomes larger.

Then, the vehicle driving assistance apparatus 10 calculates a feedforward steering torque TQ_FF based on the target steering angle θtgt. The feedforward steering torque TQ_FF is a steering torque based on the target steering angle θtgt and is a steering torque to be applied to the steering mechanism 20 in order to make the deviation amount ΔW zero. The feedforward steering torque TQ_FF is calculated as a larger value as the target steering angle θtgt becomes larger.

Further, the vehicle driving assistance apparatus 10 acquires a steering angle difference Δθ. The steering angle difference Δθ is a difference of the actual steering angle θact with respect to the target steering angle θtgt (Δθ=θtgt−θact).

Then, the vehicle driving assistance apparatus 10 calculates a feedback steering torque TQ_FB based on the steering angle difference Δθ. The feedback steering torque TQ_FB is a steering torque calculated based on the steering angle difference Δθ and is a steering torque to be applied to the steering mechanism 20 in order to make the steering angle difference Δθ zero. In other words, the feedback steering torque TQ_FB is a steering torque to be applied to the steering mechanism 20 in order to make the deviation amount ΔW zero. The feedback steering torque TQ_FB is calculated as a larger value as the steering angle difference Δθ becomes larger.

In this example, the feedback steering torque TQ_FB is obtained by summing a proportional steering torque TQ_P, an integral steering torque TQ_I, and a derivative steering torque TQ_D. Here, the proportional steering torque TQ_P is a steering torque calculated based on a proportional term in a PID control. The proportional term is calculated based on the steering angle difference Δθ in the PID control. Further, the integral steering torque TQ_I is a steering torque calculated based on an integral term in the PID control. The integral term is calculated based on the steering angle difference Δθ in the PID control. Further, the derivative steering torque TQ_D is a steering torque calculated based on a derivative term in the PID control. The derivative term is calculated based on the steering angle difference Δθ in the PID control.

As described above, the feedback steering torque TQ_FB includes a proportional component, an integral component, and a derivative component based on the steering angle difference Δθ. Accordingly, after the deviation amount ΔW becomes larger than zero, the feedback steering torque TQ_FB gradually increases until the deviation amount ΔW becomes zero.

Then, the vehicle driving assistance apparatus 10 calculates the target steering torque TQtgt by adding the feedback steering torque TQ_FB to the feedforward steering torque TQ_FF (TQtgt=TQ_FF+TQ_FB).

Next, the vehicle driving assistance apparatus 10 proceeds with the process to a step S250 to execute a steering torque control. in this case, the vehicle driving assistance apparatus 10 applies a steering torque corresponding to the target steering torque TQtgt calculated at the step S245 to the steering mechanism 20. Next, the vehicle driving assistance apparatus 10 proceeds with the process to the step S295 to terminate the process of this routine once.

As described above, during execution of the lane keeping control, when the host vehicle 100 deviates from the target traveling line Rtgt, the vehicle driving assistance apparatus 10 calculates at least the feedback steering torque TQ_FB and applies a steering torque corresponding to the feedback steering torque TQ_FB to the steering mechanism 20.

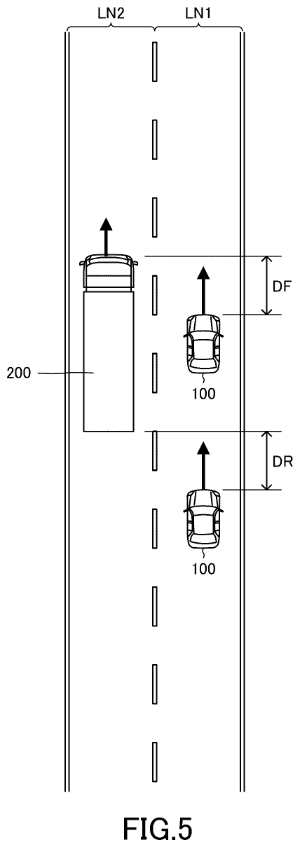

On the other hand, when the vehicle driving assistance apparatus 10 determines “Yes” at the step S210, the vehicle driving assistance apparatus 10 proceeds with the process to a step S215 to acquire a rear end distance DR. As shown in FIG. 5, the rear end distance DR is a distance between a front end of the host vehicle 100 and a rear end of the adjacent vehicle 200 in the host vehicle traveling direction DIR. It should be noted that the rear end distance DR becomes smaller than zero when the front end of the host vehicle 100 is located forward beyond the rear end of the adjacent vehicle 200.

Next, the vehicle driving assistance apparatus 10 proceeds with the process to a step S220 to determine whether or not an attracting pressure condition C3 is satisfied.

The attracting pressure condition C3 is satisfied when the rear end distance DR is shortened to a predetermined rear end distance DRth. Then, the attracting pressure condition C3 continues to be satisfied until a pushing pressure condition C5 described later is satisfied or until the rear end distance DR becomes larger than the predetermined rear end distance DRth after the attracting pressure condition C3 is satisfied. Accordingly, the attracting pressure condition C3 becomes unsatisfied when the pushing pressure condition C5 described later is satisfied or when the rear end distance DR becomes larger than the predetermined rear end distance DRth after the attracting pressure condition C3 is satisfied. It should be noted that the predetermined rear end distance DRth is set to a distance shorter than the predetermined distance Dth.

When the attracting pressure condition C3 is satisfied, since the front end of the host vehicle 100 has become close to the rear end of the adjacent vehicle 200, it is predicted that the host vehicle 100 starts overtaking the adjacent vehicle 200. Accordingly, when the attracting pressure condition C3 is satisfied, it is predicted that the host vehicle 100 starts overtaking the adjacent vehicle 200 and that the attracting pressure is generated between the host vehicle 100 and the adjacent vehicle 200. Accordingly, the predetermined rear end distance DRth is set to a sufficiently small value such that it is possible to determine start of overtaking of the adjacent vehicle 200 by the host vehicle 100. In particular, the predetermined rear end distance DRth is set to a value equal to or larger than zero, and may be set to zero.

It should be noted that the attracting pressure is a pressure generated between the host vehicle 100 and the adjacent vehicle 200 when the host vehicle 100 is traveling alongside the adjacent vehicle 200 in order to overtake the adjacent vehicle 200, and is a pressure that draws the host vehicle 100 toward the adjacent vehicle 200.

It should be noted that the vehicle driving assistance apparatus 10 acquires the rear end distance DR based on the surrounding information IS. That is, the vehicle driving assistance apparatus 10 detects the positional relationship between the adjacent vehicle 200 and the host vehicle 100.

Further, during execution of the lane keeping control, the vehicle driving assistance apparatus 10 determines whether or not an inter-vehicle pressure generated between the host vehicle 100 and the adjacent vehicle 200 is the attracting pressure based on the rear end distance DR. That is, during execution of the lane keeping control, the vehicle driving assistance apparatus 10 determines whether or not the inter-vehicle pressure generated between the host vehicle 100 and the adjacent vehicle 200 is the attracting pressure based on the positional relationship between the adjacent vehicle 200 and the host vehicle 100. In particular, the vehicle driving assistance apparatus 10 determines whether or not the attracting pressure is generated based on the positional relationship between the front end of the host vehicle 100 and the rear end of the adjacent vehicle 200.

When the vehicle driving assistance apparatus 10 determines “No” at the step S220, the vehicle driving assistance apparatus 10 proceeds with the process to the step S245 to calculate the target steering torque TQtgt as described above. Next, the vehicle driving assistance apparatus 10 proceeds with the process to the step S250 to execute the steering torque control as described above. In this case, the vehicle driving assistance apparatus 10 applies a steering torque corresponding to the target steering torque TQtgt calculated at the step S245 to the steering mechanism 20. Next, the vehicle driving assistance apparatus 10 proceeds with the process to the step S295 to terminate the process of this routine once.

On the other hand, when the vehicle driving assistance apparatus 10 determines “Yes” at the step S220, the vehicle driving assistance apparatus 10 proceeds with the process to a step S225 to acquire a front end distance DF. As shown in FIG. 5, the front end distance DF is a distance between the front end of the host vehicle 100 and a front end of the adjacent vehicle 200 in the host vehicle traveling direction DIR. It should be noted that the front end distance DF becomes smaller than zero when the front end of the host vehicle 100 is located forward beyond the front end of the adjacent vehicle 200.

Next, the vehicle driving assistance apparatus 10 proceeds with the process to a step S230 to determine whether or not a pushing pressure condition C5 is satisfied.

The pushing pressure condition C5 is satisfied when the front end distance DF is shortened to a predetermined front end distance DFth. On the other hand, the pushing pressure condition C5 becomes unsatisfied when a value of the feedback steering torque TQ_FB becomes zero by the process of a step S235 described later. It should be noted that the predetermined front end distance DFth is set to a distance shorter than a length of the adjacent vehicle 200 in the host vehicle traveling direction DIR.

When the pushing pressure condition C5 is satisfied, since the front end of the host vehicle 100 has become close to the front end of the adjacent vehicle 200, it is predicted that the host vehicle 100 completes overtaking the adjacent vehicle 200. Accordingly, when the pushing pressure condition C5 is satisfied, it is predicted that the host vehicle 100 completes overtaking the adjacent vehicle 200 and that the pushing pressure is generated between the host vehicle 100 and the adjacent vehicle 200. Accordingly, the predetermined front end distance DFth is set to a sufficiently small value such that it is possible to determine completion of overtaking of the adjacent vehicle 200 by the host vehicle 100. In particular, the predetermined front end distance DFth is set to a value equal to or larger than zero, and may be set to zero.

It should be noted that the pushing pressure is a pressure generated between the host vehicle 100 and the adjacent vehicle 200 when the host vehicle 100 overtakes the adjacent vehicle 200, and is a pressure that pushes the host vehicle 100 in a direction away from the adjacent vehicle 200.

Further, the vehicle driving assistance apparatus 10 acquires the front end distance DF based on the surrounding information IS. That is, the vehicle driving assistance apparatus 10 detects the positional relationship between the adjacent vehicle 200 and the host vehicle 100.

Further, during execution of the lane keeping control, the vehicle driving assistance apparatus 10 determines whether or not an inter-vehicle pressure generated between the host vehicle 100 and the adjacent vehicle 200 is the pushing pressure based on the front end distance DF. That is, during execution of the lane keeping control, the vehicle driving assistance apparatus 10 determines whether or not the inter-vehicle pressure generated between the host vehicle 100 and the adjacent vehicle 200 is the pushing pressure based on the positional relationship between the adjacent vehicle 200 and the host vehicle 100. In particular, the vehicle driving assistance apparatus 10 determines whether or not the pushing pressure is generated based on the positional relationship between the front end of the host vehicle 100 and the front end of the adjacent vehicle 200.

When the vehicle driving assistance apparatus 10 determines “No” at the step S230, the vehicle driving assistance apparatus 10 proceeds with the process to the step S245 to calculate the target steering torque TQtgt as described above. Next, the vehicle driving assistance apparatus 10 proceeds with the process to the step S250 to execute the steering torque control as described above. In this case, the vehicle driving assistance apparatus 10 applies a steering torque corresponding to the target steering torque TQtgt calculated at the step S245 to the steering mechanism 20. Next, the vehicle driving assistance apparatus 10 proceeds with the process to the step S295 to terminate the process of this routine once.

On the other hand, when the vehicle driving assistance apparatus 10 determines “Yes” at the step S230, the vehicle driving assistance apparatus 10 proceeds with the process to a step S235 to calculate the target steering torque TQtgt. Here, the vehicle driving assistance apparatus 10 sets, as the target steering torque TQtgt, a steering torque obtained by adding the feedback steering torque TQ_FB to the feedforward steering torque TQ_FF while reducing the feedback steering torque TQ_FB at a predetermined change rate CR. At this time, the vehicle driving assistance apparatus 10 reduces the feedback steering torque TQ_FB so as to become zero within a predetermined time Tth.

It should be noted that the predetermined time Tth is set to a sufficiently short time suitable for suppressing instability of a behavior of the host vehicle 100 caused by the feedback steering torque TQ_FB. In other words, the predetermined change rate CR is set to a sufficiently large value suitable for suppressing instability of a behavior of the host vehicle 100 caused by the feedback steering torque TQ_FB.

As described above, during execution of the lane keeping control, the vehicle driving assistance apparatus 10 determines whether the inter-vehicle pressure generated between the host vehicle 100 and the adjacent vehicle 200 is the attracting pressure or the pushing pressure based on the positional relationship between the adjacent vehicle 200 and the host vehicle 100, and reduces the feedback steering torque TQ_FB to zero within the predetermined time Tth at a timing when the inter-vehicle pressure changes from the attracting pressure to the pushing pressure.

Next, the vehicle driving assistance apparatus 10 proceeds with the process to a step S240 to execute the steering torque control. In this case, the vehicle driving assistance apparatus 10 applies a steering torque corresponding to the target steering torque TQtgt calculated at the step S235 to the steering mechanism 20. Next, the vehicle driving assistance apparatus 10 proceeds with the process to the step S295 to terminate the process of this routine once.

The above is the operation of the vehicle driving assistance apparatus 10.

When the host vehicle 100 is traveling alongside the adjacent vehicle 200 in order to overtake the adjacent vehicle 200, the attracting pressure that draws the host vehicle 100 toward the adjacent vehicle 200 is applied to the host vehicle 100. As a result, the host vehicle 100 deviates from the target traveling line Rtgt. During execution of the lane keeping control, the feedback steering torque TQ_FB gradually increases in order to eliminate this deviation.

On the other hand, when the host vehicle 100 overtakes the adjacent vehicle 200, the pushing pressure that pushes the host vehicle 100 in a direction away from the adjacent vehicle 200 is applied to the host vehicle 100. That is, the inter-vehicle pressure generated between the host vehicle 100 and the adjacent vehicle 200 changes from the attracting pressure to the pushing pressure. At this time, if the feedback steering torque TQ_FB remains large, the host vehicle 100 is largely steered in a direction away from the adjacent vehicle 200, and a behavior of the host vehicle 100 becomes unstable.

According to the vehicle driving assistance apparatus 10, when the inter-vehicle pressure generated between the host vehicle 100 and the adjacent vehicle 200 changes from the attracting pressure to the pushing pressure, the feedback steering torque TQ_FB is made zero within the predetermined time Tth. Accordingly, instability of the behavior of the host vehicle 100 is suppressed.

It should be noted that the present invention is not limited to the above-described embodiment, and various modifications can be adopted within the scope of the present invention.

What is claimed is:

1. A vehicle driving assistance apparatus comprising an electronic control unit that executes a steering control of setting, within a host vehicle traveling lane in which a host vehicle is traveling, a target traveling line extending along the host vehicle traveling lane, and autonomously applying a steering torque to a steering mechanism of the host vehicle such that the host vehicle travels along the target traveling line,
wherein the electronic control unit is configured to, during execution of the steering control, when the host vehicle deviates from the target traveling line, calculate a feedback steering torque that is a steering torque to be applied to the steering mechanism in order to make a deviation amount of the host vehicle from the target traveling line zero, and apply a steering torque corresponding to the feedback steering torque to the steering mechanism, and
wherein the electronic control unit is configured to:
detect an adjacent vehicle that is another vehicle traveling in the same direction as the host vehicle in a lane adjacent to the host vehicle traveling lane and traveling ahead of the host vehicle, and detect a positional relationship between the adjacent vehicle and the host vehicle; and
during execution of the steering control, determine whether an inter-vehicle pressure generated between the host vehicle and the adjacent vehicle is an attracting pressure or a pushing pressure based on the positional relationship, and reduce the feedback steering torque to zero within a predetermined time at a timing when the inter-vehicle pressure changes from the attracting pressure to the pushing pressure.

2. The vehicle driving assistance apparatus according to claim 1, wherein the electronic control unit is configured to determine whether or not the attracting pressure is generated based on a positional relationship between a front end of the host vehicle and a rear end of the adjacent vehicle.

3. The vehicle driving assistance apparatus according to claim 1, wherein the electronic control unit is configured to determine whether or not the pushing pressure is generated based on a positional relationship between a front end of the host vehicle and a front end of the adjacent vehicle.

4. A vehicle driving assistance method of executing a steering control of setting, within a host vehicle traveling lane in which a host vehicle is traveling, a target traveling line extending along the host vehicle traveling lane, and autonomously applying a steering torque to a steering mechanism of the host vehicle such that the host vehicle travels along the target traveling line,
wherein the vehicle driving assistance method comprises a step of, during execution of the steering control, when the host vehicle deviates from the target traveling line, calculating a feedback steering torque that is a steering torque to be applied to the steering mechanism in order to make a deviation amount of the host vehicle from the target traveling line zero, and applying a steering torque corresponding to the feedback steering torque to the steering mechanism, and
wherein the vehicle driving assistance method comprises steps of:
detecting an adjacent vehicle that is another vehicle traveling in the same direction as the host vehicle in a lane adjacent to the host vehicle traveling lane and traveling ahead of the host vehicle, and detecting a positional relationship between the adjacent vehicle and the host vehicle; and
during execution of the steering control, determining whether an inter-vehicle pressure generated between the host vehicle and the adjacent vehicle is an attracting pressure or a pushing pressure based on the positional relationship, and reducing the feedback steering torque to zero within a predetermined time at a timing when the inter-vehicle pressure changes from the attracting pressure to the pushing pressure.

5. A computer-readable non-transitory storage medium storing a vehicle driving assistance program which executes a steering control of setting, within a host vehicle traveling lane in which a host vehicle is traveling, a target traveling line extending along the host vehicle traveling lane, and autonomously applying a steering torque to a steering mechanism of the host vehicle such that the host vehicle travels along the target traveling line,
wherein the vehicle driving assistance program is configured to, during execution of the steering control, when the host vehicle deviates from the target traveling line, calculate a feedback steering torque that is a steering torque to be applied to the steering mechanism in order to make a deviation amount of the host vehicle from the target traveling line zero, and apply a steering torque corresponding to the feedback steering torque to the steering mechanism, and
wherein the vehicle driving assistance program is configured to:
detect an adjacent vehicle that is another vehicle traveling in the same direction as the host vehicle in a lane adjacent to the host vehicle traveling lane and traveling ahead of the host vehicle, and detect a positional relationship between the adjacent vehicle and the host vehicle; and
during execution of the steering control, determine whether an inter-vehicle pressure generated between the host vehicle and the adjacent vehicle is an attracting pressure or a pushing pressure based on the positional relationship, and reduce the feedback steering torque to zero within a predetermined time at a timing when the inter-vehicle pressure changes from the attracting pressure to the pushing pressure.
